(19) United States
(12) Patent Application Publication
(10) Pub. No.: US 2018/0267726 A1
(43) Pub. Date: Sep. 20, 2018

(54) MEMORY SPACE MANAGEMENT AND MEMORY ACCESS CONTROL METHOD AND APPARATUS

(71) Applicant: MStar Semiconductor, Inc., Hsinchu Hsien (TW)

(72) Inventors: MING YONG SUN, Shanghai (CN); Yung Chang, Hsinchu County (TW); CHUNG-CHING CHEN, Hsinchu County (TW); YI-HAO LO, Hsinchu County (TW)

(21) Appl. No.: 15/908,888

(22) Filed: Mar. 1, 2018

(30) Foreign Application Priority Data
Mar. 14, 2017 (CN) 201710150970.3

(51) Int. Cl. G06F 3/06

(52) U.S. Cl. CPC G06F 3/0622; G06F 3/0673; G06F 3/0634

(57) ABSTRACT

Memory space management and memory access control method and apparatus are provided. The method includes: upon receiving an access request, acquiring an access address and an accessor identifier in the access request; checking a current state of a memory space pointed by the access address to obtain a check result, wherein the state of the memory space includes a first state and a second state; determining whether the accessor identifier belongs to an access permission set among a plurality of access permission sets that corresponds to the check result; and generating an instruction according to the check result, wherein the instruction indicates whether or not the accessor is permitted to access the memory space. With the above method, the invention reduces resource waste and system costs.

This application claims the benefit of China application Serial No. 201710150970.3, filed Mar. 14, 2017, the subject matter of which is incorporated herein by reference.

### BACKGROUND OF THE INVENTION

### Field of the Invention

The invention relates to the field of storage, and more particularly to memory space management and memory access control method and apparatus.

### Description of the Related Art

The security issue of a terminal device in an open environment has drawn much attention in the recent years, and the subjects concerned include not only terminal users, but also service providers, mobile service operators and chip manufacturers, and more particularly for televisions as well as Ultra High Definition (UHD) and UHD+ television streaming media content needing to be processed by set-top boxes (STB).

To protect media content, Digital Rights Management (DRM) based on Trusted Execution Environment (TEE) technologies have substantially become an essential requirement that needs to be met by UHD/UHD+ content providers. The TEE is an operation environment that coexists with Rich OS (usually a Linux-based operating system) in an apparatus. A trusted application (TA) developed by a third-party manufacturer operates in the TEE to provide Rich OS with a security service. The TEE itself is protected by a security boot technology.

In the TEE, a security memory prohibits the access from a non-security hardware unit (HW IP, usually representing the Rich OS end). Thus, an image decoding register and an image enhancement register are stored in the security memory to prevent piracy. Because the position of the security memory is configured by a security boot process executed by a booting procedure, the security memory has a position and a size that cannot be adjusted as desired, and can only be activated and deactivated when operating in the TEE environment.

As shown in FIG. 1, a security memory 12 is provided as an independent unit outside a system memory 11 in current products. A security memory needed by some terminal devices is quite large. For example, for a playback terminal supporting UHD and a chip supporting unidirectional UHD decoding and image enhancement, the total capacity of a security memory needed is over 200 MB; for a chip supporting bidirectional UHD decoding or supporting UHD+ decoding, the total capacity of a security memory needed is over 350 MB. As a result, the terminal device often requires an independent large-capacity security memory, leading to an increase in system costs. Further, such large-capacity security memory is in an idle state when a hardware unit is not operating, further causing storage resource waste.

### SUMMARY OF THE INVENTION

The invention is directed to memory space management and memory access control method and apparatus for reducing storage resource waste and system costs.

The present invention provides a memory space management method for managing a system memory accessed by a hardware unit or a processor. The method includes: upon receiving an operation request issued from the hardware unit, determining, according to a type of the operation request, whether an operation requested by the hardware unit is accessing a security memory region in the system memory; and if so, changing the security memory region needed to be accessed in the system memory from a predetermined first state to a second state, and setting the hardware unit to a security state. When the security memory region is in the first state, it means that the security memory region is permitted to be accessed only by the processor and but not the hardware unit. When the security memory region is in the second state, it means that the security memory region is permitted to be accessed only by the hardware unit in the security state.

The present invention provides a memory access control method for controlling a system memory accessed by a processor or a hardware unit. The method includes: upon receiving an access request, acquiring an access address and an identifier of an accessor in the access request; checking a current state of a memory space pointed by the access address to obtain a check result, wherein the state of the memory space includes a first state and a second state; determining whether the identifier of the accessor belongs to an access permission set among a plurality of access permission sets that corresponds to the check result, wherein the plurality of access permission sets include a first access permission set corresponding to the first state and a second access permission set corresponding to the second state; and generating an instruction according to the determination result, wherein the instruction indicates whether or not the accessor is permitted to access the memory space.

The present invention further provides a non-transient computer-readable storage medium for managing a system memory accessed by a processor or a hardware unit. The non-transient computer-readable storage medium stores a code readable and executable by a processor. The code includes: a first sub-code, upon receiving an operation request issued from the hardware unit, the first sub-code determining, according to a type of the operation request, whether an operation requested by the hardware unit is accessing a security memory region in the system memory; and a second sub-code, changing the security memory region needed to be accessed in the system memory from a predetermined first state to a second state, and setting the hardware unit to a security state. When the security memory region is in the first state, it means that the security memory region is permitted to be accessed only by the processor but not the hardware unit. When the security memory region is in the second state, it means that the security memory region is permitted to be accessed only by the hardware unit in the security state.

The present invention further provides a memory access control apparatus, which is connected to a system memory via a bus and is for controlling a processor or a hardware unit that accesses the system memory. The memory access control apparatus includes: a plurality of protection groups, each of which looking up an access permission list according to an accessor identifier to obtain a search result; a checking unit, checking, according to an access address, whether a current state of a memory space pointed by the access address is a first state or a second state; and a determining unit, connected to the plurality of protection groups and the checking unit, receiving the plurality of search results of the plurality of protection groups and the check result, selecting one search result from the plurality of search results according to the check result, and generating a determination signal according to the selected search result.

The present invention further provides a memory access control apparatus, which is connected to a system memory via a bus and is for controlling a processor or a hardware unit that access the system memory. The memory access control apparatus includes: a checking unit, checking, according to an access address, whether a current state of a memory space pointed by the access address is a first state or a second state to obtain a check result; a plurality of protection groups, connected to the checking unit, wherein one of the protection groups that corresponds to the check result looks up an access permission list according to an access identifier to obtain a search result; and a determining unit, connected to the plurality of protection groups, receiving the search result of the protection group corresponding to the check result, and generating a determination signal according to the search result.

In the above solutions, a security memory region is provided in the system memory, and a processor changes a state of the security memory region according to an operation request of a hardware unit. Thus, upon receiving an access request for accessing the security memory region, a memory controller defines whether or not an issuer of the access request is permitted to access according to the state of the security memory region. More specifically, the memory controller defines that the security memory region is permitted to be accessed only by the processor if the security memory region is in the first state, and defines that the security memory region is permitted to be accessed only by the hardware unit when the security memory region is in the second state. By setting the security memory region to different states, an object permitted to access the security memory region is defined, preventing one of the processor and the hardware unit in a security state from accessing data stored by the other, implementing, without involving an independent security memory, time-division sharing of the system memory and the security memory region while ensuring the respective securities of the system memory and the security memory region, and reducing storage resource waste and system costs.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a conventional structure between a system memory and a security memory;

FIG. 2 is a schematic diagram of a structure between a system memory and a security memory of the present invention;

FIG. 3 is a flowchart of a memory space management method according to an embodiment of the present invention;

FIG. 4 is a schematic diagram of another structure between a system memory and a security memory of the present invention;

FIG. 5 is a flowchart of a memory access control method according to an embodiment of the present invention;

FIG. 6 is a partial flowchart of a memory access control method according to another embodiment of the present invention;

FIG. 7 is a partial flowchart of a memory access control method according to another embodiment of the present invention;

FIG. 8 is a schematic diagram of a process of recycling security memory fragments according to an embodiment of the present invention;

FIG. 9 is a schematic diagram of a system structure implementing a memory access control method of the present invention;

FIG. 10 is a structural schematic diagram of a memory access control apparatus according to an embodiment of the present invention;

FIG. 11 is a structural schematic diagram of a checking unit according to an embodiment of the present invention;

FIG. 12 is a structural schematic diagram of a determining unit according to an embodiment of the present invention; and

FIG. 13 is a structural schematic diagram of a memory access control apparatus according to another embodiment of the present invention.

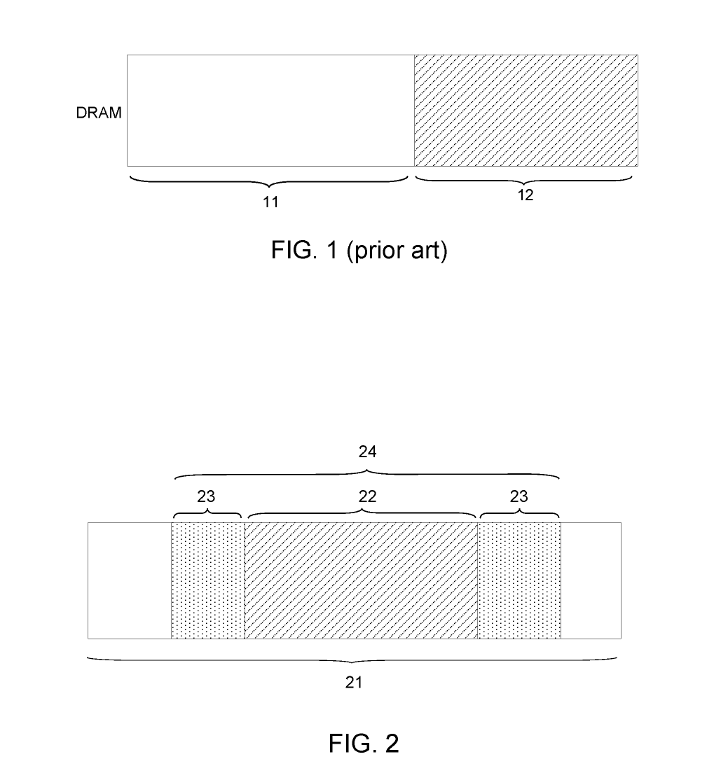

### DETAILED DESCRIPTION OF THE INVENTION

In the following description, for illustration but not limitation purposes, specific details of specific system structures, interfaces and technologies are given to help better understand the present invention. However, one person skilled in the art can appreciate that, there are other implementation means for achieving the present invention without these specific details. In other circumstances, details of commonly known devices, circuits and methods are omitted to eliminate these unnecessary details from hindering the description of the present invention.

To better understand the present invention, some elements and terms in the present invention are described below.

A processor in the disclosure is a core circuit for operating in a terminal operating system. More specifically, the processor is operable in a secure environment and in a non-secure environment, e.g., TEE and Rich OS system environments. These two environments may also be implemented by the same processor or individually by different processors—such is not limited by the present invention.

A hardware unit (also referred to as HW IP) in the disclosure is specifically a hardware circuit other than the processor in a terminal device, for example, a media-related hardware unit such as an image decoder, an image enhancement processor, a display driver, an on-screen display (OSD) mixer. The hardware unit has a security state and a non-security state, and currently executes a security operation when in the security state or currently executes a normal operation when in the non-security state. For example, in a TEE and Rich OS dual system terminal device, when the hardware unit in a TEE operates a trusted application (TA) of a third-party manufacturer and needs to access content in a security memory region, the hardware unit needs to switch to the security state; when the hardware unit executes a common application of a third-party manufacturer and needs to access a common memory region needing no protection, the hardware unit needs to switch to the non-security state.

In the disclosure, a system memory is a storage space in which an operating system of a terminal device stores instructions and data, which are for the access of a processor. More specifically, the system memory may be a dynamic random access memory (DRAM). In a terminal device using a Linux operating system, the system memory is a storage space managed by a kernel (also referred to as a Linux kernel memory), and is managed by a kernel of the operating system (e.g., a Linux kernel) or accessed by the kernel of the operating system and applications.

In response to the issue of memory resource waste caused by a conventional security memory region being independent from a system memory, the present invention provides a solution of time-division sharing a system memory and a security memory region. More specifically, a segment of a memory space in a system memory is labeled as a security memory region, which can be accessed by a hardware unit in a security state or by a processor according to different configuration states. A security memory region may also be provided independently outside the system memory. The security memory region in the system memory can be temporarily accessed by certain hardware units in a security state, and the security memory region outside the system memory can be more permanently accessed by certain hardware units in a security state.

Further, in the present invention, another segment of memory space in a system memory may be labeled as a non-security memory region, which can be accessed by hardware units in a non-security state, hardware units in a secure and a non-security state, or a processor.

As shown in FIG. 2, a security memory region 22 and a non-security memory region 23 may be, in a system memory 21, one segment or multiple segments of physical memory regions allocated by a continguous memory allocator (CMA). The security memory region 22 and the non-security memory region 23 form a predetermined memory region 24 allocated by the CMA. More specifically, the security memory region 22 and the non-security memory region 23 may be provided, for example but not limited to, any desired positions in the system memory.

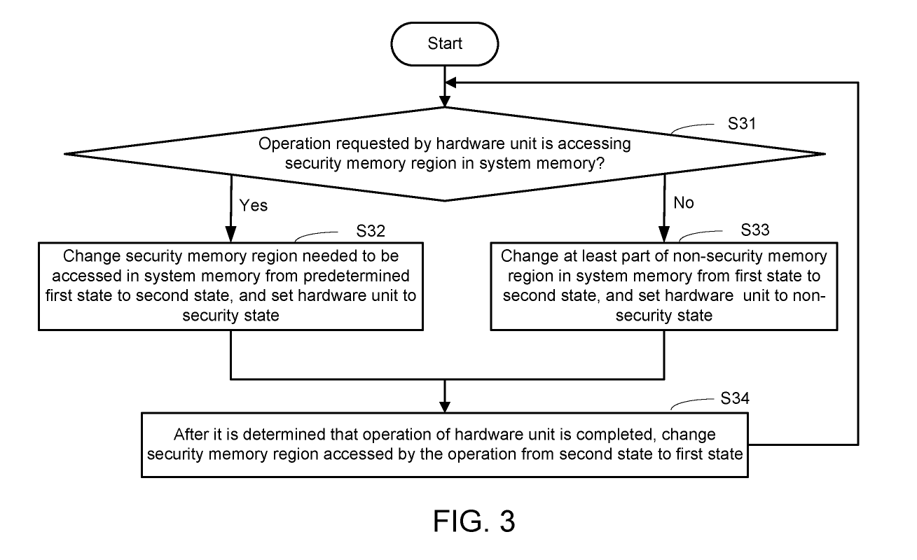

FIG. 3 shows a flowchart of a memory space management method according to an embodiment of the present invention. In this embodiment, the method is performed by a processor, and is for managing a system memory accessed by a hardware unit or a processor. The method includes following steps.

In step S31, upon receiving an operation request issued by a hardware unit, a processor determines, according to a type of the operation request, whether an operation requested by the hardware unit is accessing a security memory region in the system memory.

The processor in a terminal device allocates in advance a part of continuous memory in the system memory as a security memory region. For example, when the system is activated (i.e., when the terminal device is booted), the processor allocates one or multiple segments of continuous memory in the system memory as a security memory region according to a memory allocation policy. More specifically, the processor may operate a driver to request the system to obtain the security memory region by means of a CMA. According to actual requirements, the security memory region may be again allocated in an operation process after having booted the terminal device. More specifically, the memory allocation policy may allocate security memory regions corresponding to different capacities according to different projects that need to be operated by the terminal device. To ensure the security of the security memory region, the above allocation is performed by a processor in a security state, e.g., a processor operating in a TEE in the terminal device; whereas, a processor in a non-security state, e.g., a processor operating in Rich OS cannot modify or control the already set security memory region.

In this embodiment, after receiving the operation request of the hardware unit, the processor first determines whether the type of the operation request is a security operation request needing to occupy a storage space. For example, assuming that a hardware unit requests for a security image path, it is determined whether the operation request needs to access at least a part of the security memory region as a memory space used in image decoding and image enhancement processes by the security image path thereof. If it is determined that the operation request is a security operation request needing to occupy a storage space, it is determined that the operation request needs to access a security memory region in the system memory, and step S32 is performed. If it is determined that the operation request is a non-security operation request needing to occupy a storage space, it is determined that the operation request does not need to access the security memory region in the system memory, and step S33 is performed.

In step S32, the processor changes the security memory region needed to be accessed in the system memory from a predetermined first state to a second state, and sets the hardware unit to a security state.

The security memory region predetermined in the system memory may have a first state and a second state. When the security memory region is in the first state, it means that the security memory region is permitted to be accessed only by the processor but not the hardware unit. When the security memory region is in the second state, it means that the security memory region is permitted to be accessed only by the hardware unit in a security state.

Predeterminedly, the state of the security memory region predetermined by the processor is the first state, i.e., the security memory region is permitted to be accessed only by the processor and the hardware unit does not have any access permission. When it is determined that the current operation of the hardware unit needs to use the security memory region, a segment of continuous security memory region is allocated by means of a CMA, and current data in the security memory region needed to be used by the operation is relocated to another space in the system memory (data when the security memory region is in the first state is data accessed by the processor, and is first relocated to another storage space to prevent any processor data loss). The processor further changes the security memory region needed to be used for the operation from the first state to the second state. More specifically, the size of the security memory region of which the state needs to be changed may be allocated according to the type of the operation request of the hardware unit. For example, assume that the system memory is predetermined with a 300 MB security memory region. If the current operation is a one-path image decoding request, the state of 100 MB security memory region in the system memory is changed according to the above method, so as to use the 100 MB security memory region for decoding data for storing images of the hardware unit.

Further, the processor may label the hardware unit as being in a security state to ensure that the hardware unit has permission to access the security memory region in the second state during the operation process. More specifically, the state of each hardware unit may be stored in form of a list in the processor and in the storage space accessible to the memory controller.

In one application, the security memory region is divided into a first quantity of memory pages (also referred to as entries), each of which has a constant size. More specifically, each memory page may have a size of 1 MB or 512 KB, and is provided with a first control bit. In step S32, the security memory region needed to be accessed in the system memory is changed from the predetermined first state to the second state specifically by the following steps.

In step S321, it is determined that the size of the security memory region needed to be accessed is a second quantity of memory pages.

In step S322, the first control bit of each of the second quantity of memory pages in the security memory region is changed from a first word to a second word.

When the first control bit is the first word, it means that the memory page is in the first state, i.e., the memory of the memory page is recycled for further use of the processor; when the first control bit is the second word, it means that the memory page is in the second state, i.e., the memory of the memory page is allocated to the hardware unit in a security state, and the system memory cannot use the memory for internal use thereof. The first quantity is greater than the second quantity.

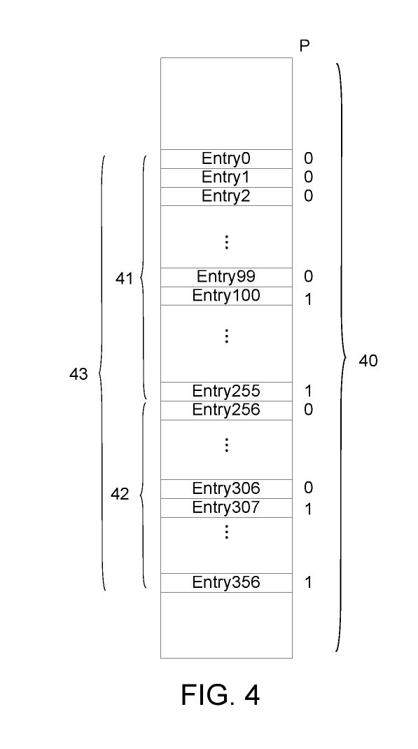

As shown in FIG. 4, a system memory 40 is predetermined with a total of 256 memory pages, from Entry0 to Entry 255, as a security memory region 41. When the current first control bit P of each of the 256 memory page is set to 1, it means that the memory page is initially permitted to be accessed only by the processor. The processor determines that the storage space needed by the current operation is 100 memory pages according to the type of the current operation request, and changes the values of the first control bits of Entry0 to Entry 99 in the security memory region 41 to 0, to indicate that the 100 memory pages are currently permitted to be accessed only by the hardware unit in a security state.

In step S33, the processor changes at least a part of a non-security memory region in the system memory from the first state to the second state, and sets the hardware unit to a non-security state.

In this embodiment, the system memory is predetermined therein with a non-security memory region, which also has the first state and the second state. When the non-security memory region in the first state, it means that the non-security memory region is permitted to be accessed only by the processor; when the non-security memory region is in the second state, it means that the non-security memory region is permitted to be accessed by the hardware unit in a security state or in a non-security state, or is permitted to be accessed only by the hardware unit in a non-security state.

Predeterminedly, the state of the non-security memory region predetermined by the processor is the first state, i.e., the non-security memory region is permitted to be accessed by the processor and the hardware unit does not have any access permission. When it is determined that the current operation of the hardware unit does not need to use the security memory region, i.e., when the non-security memory region is used, the non-security memory region needed to be used by the operation is allocated from the system memory by means of a CMA, and the non-security memory region needed to be used by the operation is changed from the first state to the second state. Similar to step S32, the size of the non-security memory region of which the state needs to be change may be allocated according to type of the operation request of the hardware unit.

Further, the processor labels the hardware unit to a non-security state to ensure that, because the hardware unit current performs a non-security operation, only the non-security memory region in the second state is permitted to be accessed, so as to prevent the hardware unit from obtaining any permission for accessing the security memory range in the second state in the operation process.

In one application, the non-security memory region may be divided into a third quantity of memory pages. In step S33, at least a part of the non-security memory region in the system memory are change from the first state to the second state by the following sub-steps.

In step S331, it is determined that the size of the non-security memory region needed to be accessed is a fourth quantity of memory pages.

In step S332, the first control bit of each of the fourth quantity of memory pages in the non-security memory region is changed from the first word to the second word.

When the first control bit is the first word, it means that the memory page is in the first state, i.e., the memory of the memory page is recycled for further use of the processor. When the first control bit is the second word, it means that the memory page is in the second state, i.e., the memory of the memory page is allocated to the hardware unit, and the system memory cannot use the memory for internal use thereof. The third quantity is greater than the fourth quantity.

As shown in FIG. 4, the system memory 40 is predetermined with a total of 100 memory pages from Entry256 to Entry 356 as a non-security memory region 42. The security memory region 41 and the non-security memory region 42 form a predetermined memory region 43 of the system memory. The range 43 is a range that is allocated by the CMA, and the remaining regions outside of the predetermined memory region 43 are for the access of the processor. When the value of the current first control bit P of each of the 100 memory pages of the non-security memory region 42 is set to 1, it means that the memory page is initially permitted to be accessed only by the processor but not the hardware unit. The processor determines that the storage space needed by the operation is 50 memory pages according to the type of the current operation request, and changes the values of the first control bits P of Entry256 to Entry 306 in the non-security memory region 42 to 0 to indicate that these 50 memory pages are permitted to be accessed only by the hardware unit in a non-security state or by the hardware unit in any state but not by the processor.

In other embodiments, the system memory may not include the non-security memory region; further, the method correspondingly does not include step S33, that is, when the processor determines that the operation of the hardware unit does not need to access the secure memory region in step S31, the process ends.

In step S34, after determining that the operation of the hardware unit is completed, the processor changes the security memory region accessed by the operation from the second state to the first state.

Further, after the processor performs step S32 or S33, if it is determined that the operation of the hardware is completed, the processor further changes the security memory region or the non-security memory region accessed by the operation from the second state to the first state, such that the security memory region or the non-security memory region accessed is recycled for further internal use of the system memory, i.e., for exclusive use of the processor. In another embodiment, after the operation of the hardware unit is completed, the processor may first leave the state of the associated memory region unchanged, but only changes the security memory region of the non-security memory region accessed from the second state to the first state after having determined that other storage spaces of the system memory are insufficient.

Step S31 to S33 may be performed by a processor in a non-security state, e.g., a processor operating in Rich OS, so as to facilitate a Rich OS end and the CMA to flexibly allocate associated memory regions and to control the state of the memory region. In step S32, more specifically, the changing of the state of the memory range may be performed by a memory management driver module of an operating system (e.g., Linux) of a processor in a non-security state.

In other embodiments, step S31 to S33 may also be performed by a processor in a security state, or the setting of the state of hardware unit in step S32 may be performed by a processor in a security state and the other steps may be performed by a processor in a non-security state. In one application, the processor in a security state is a processor operating in a TEE, and the processor in a non-security state is a processor operating in Rich OS, i.e., a processor operating a kernel of a normal operating system (e.g., a Linux kernel).

In this embodiment, the system memory is provided with a security memory region, and the processor changes the state of the security memory region according to the operation request of the hardware unit, such that the memory controller defines whether an issuer of the access request is permitted for access according to the state of the security memory region upon receiving the access request of the security memory region. More specifically, if it is defined that the security memory region is in the first state, it is defined that only the processor is permitted to access the security memory region; if the security memory region is in the second state, it is defined that only the hardware unit in a security state is permitted to access the security memory region. Setting the security memory region to different states defines an object that is permitted to access the security memory region, preventing one of the processor and the hardware unit in a security state from accessing data stored by the other, implementing, without involving an independent security memory, time-division sharing of the system memory and the security memory region while ensuring the respective securities of the system memory and the security memory region, and reducing storage resource waste and system costs.

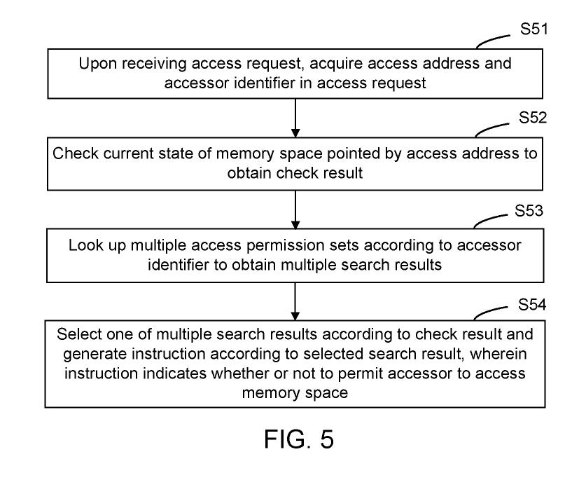

FIG. 5 shows a flowchart of a memory access control method according to an embodiment of the present invention. In this embodiment, the control method is performed by a memory controller. The memory controller is connected to at least one processor and at least one hardware unit, and performs the control method to control the processor and the hardware unit to access the above system memory, such as reading data from or writing data to the system memory. More specifically, the control method includes the following steps.

In step S51, upon receiving an access request, the memory controller acquires an access address and an accessor identifier in the access request.

The access request may be from the processor or the hardware unit, and is for requesting to access a part of the memory space in the above system memory. More specifically, the term “access” in the disclosure refers to reading or writing data.

In step S52, a current state of the memory space pointed by the access address is checked to obtain a check result.

As described the foregoing embodiment, the system memory includes a predetermined memory region, as the predetermined memory region 43 in FIG. 4, for the access of the hardware unit. In different embodiments, more specifically, the predetermined memory region 43 may include the above security memory region, or include the above security memory region and the above non-security memory region. Further, the state of the predetermined memory region may be set as in the foregoing embodiments. The memory controller may first determine whether the memory space pointed by the access address is the predetermined memory region. If so, step S52 is performed. If not, it is determined that the memory space is for access of the processor only, and the hardware unit is prohibited from accessing the memory space if the accessor is the hardware unit, thus preventing the hardware unit from unlawfully acquiring data of the processor.

In this embodiment, as shown in FIG. 4, the predetermined memory region includes a plurality of the above memory pages. If the resource sharing is targeted at only the security memory region of the predetermined memory region, only the current state of the memory space pointed by the access address is checked. In step S52, the step of checking the current state of the memory space pointed by the access address includes: reading the value of the first control bit of the memory page pointed by the access address to determine the current state of the memory page pointed by the access address. The check result indicates that, when the first control bits of the memory pages pointed by the access address are all the first word, it means that the memory space pointed by the access address is in the first state; when the first control bits of the memory pages pointed by the access address are all the second words, it means that the memory space pointed by the access address is in the second state.

In step S53, a plurality of access permission sets are looked up according to the accessor identifier to obtain a plurality of search results.

The access permission sets include identifiers of processors or hardware units permitted to access the system memory. Taking an access permission set as an access permission list for instance, it is determined whether the accessor identifier is in the access permission list to obtain a search result, which indicates the accessor identifier as being in the access permission list or as not being in the access permission list. More specifically, if only the current state of the memory space pointed by the access address is checked, the plurality of access permission lists are two access permission lists respectively corresponding to the first state and the second state.

In step S54, one of the search results is selected according to the check result, and an instruction is generated according to the selected check result. The instruction indicates whether or not the accessor is permitted to access the memory space.

More specifically, the search result of the access permission list corresponding to the check result is selected. If the search result is in the access permission list, an instruction permitting the accessor to access the memory space pointed by the access address is generated, otherwise an instruction not permitting the accessor to access the memory space pointed by the access address is generated.

It should be understood that, in this embodiment, a search result matching the check result is selected from a plurality of search results according to the check result, and so step S52 and S53 may be simultaneously performed. In other embodiments, after step S52, step S53 may be performed to select the access permission set corresponding to the check result from the plurality of access permission sets, and the access permission set is looked up according to the accessor identifier to obtain a search result, and then step S54 is performed to generate an instruction according to the search result. Steps S52 to S54 are an implementation means for determining, among a plurality of access permission sets, whether the accessor identifier belongs to an access permission set that corresponds to the check result, and generating an instruction according to the search result.

The access permission lists corresponding to different states of the memory space include different accessor identifiers. In one embodiment, assume that the access permission list corresponding to the first state includes only processor identifiers and the access permission list corresponding to the second state includes only hardware unit identifiers. Thus, in step S54, when the memory space pointed by the access address is in the first state, if the access request is issued by a processor, the processor is permitted to access the memory space, otherwise the processor is prohibited from accessing the memory space; when the memory space pointed by the access address is in the second state, if the access request is issued by a hardware unit satisfying a requirement, the hardware unit is permitted to access the memory space, otherwise the hardware unit is directly prohibited from accessing the memory space.

As described in the above embodiment, the predetermined memory region has the first state and the second state, and different types of hardware in different states are permitted to access the predetermined memory region. When the memory space pointed by the access address is in the first state, it means that the memory space is currently permitted to be accessed only by a processor. If a hardware unit requests to access the memory space pointed by the access address, the memory controller prohibits the hardware unit from accessing the memory space and issues a system abnormality message, so as to prevent the hardware unit from erroneously accessing the processor memory due to a timing error or other reasons and thus from unlawfully acquiring or modifying the processor memory. At this point, a system memory protection support (also referred to as KProtect) becomes effective, and the memory controller may use KProtect to protect the predetermined memory region. When the memory space pointed by the access address is in the second state, it means that the memory space is currently permitted to be access only by a hardware unit, and if the processor requests to access the memory space, the memory controller prohibits the processor from accessing the memory space and issues a system abnormality message, so as to prevent the processor from erroneously accessing the hardware unit memory due to a timing error or other reasons and thus from unlawfully acquiring or modifying the hardware unit memory.

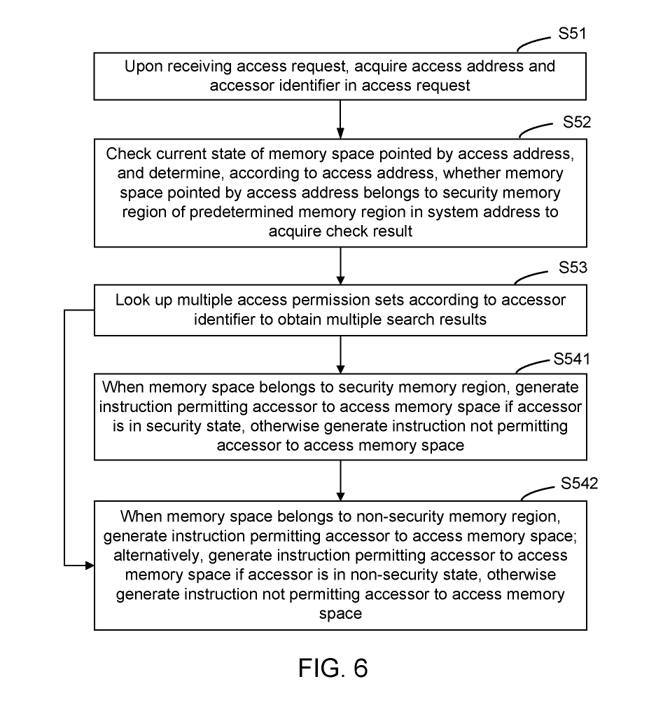

Based on the above embodiment, in yet another embodiment, if the resource sharing further needs to, in addition to targeting at a security memory region of the predetermined memory region, distinguish between a security memory region and a non-security memory region, the predetermined memory region includes the security memory region and the non-security memory region. Referring to FIG. 6, the memory access control method differs from the previous embodiment by the following.

Step S52 further includes checking whether the memory space pointed by the access address belongs to a security memory region of the predetermined memory region in the system memory.

The check result includes four scenarios: 1) the memory space pointed by the access address is the security memory region of the predetermined memory region, and the memory space is in the first state; 2) the memory space pointed by the access address is not the security memory region of the predetermined memory region, and the memory space is in the first state; 3) the memory space pointed by the access address is the security memory region of the predetermined memory region, and the memory space is in the second state; and 4) the memory space pointed by the access address is not the security memory region of the predetermined memory region, and the memory space is in the second state.

For example, each of the memory pages in the predetermined memory region is further provided with a second control bit. The second control bit indicates whether the memory page belongs to the security memory region or the non-security memory region, and has a value that is not preserved in a default value as the first control bit but is in real time calculated and obtained by the memory controller.

More specifically, the memory controller calculates, according to the relationship between the access address and an address of the security memory region of the predetermined memory region, the value of the second control bit of the memory page pointed by the access address. For example, the second control bit of the memory page pointed by the access address is a third word if the access address belongs to an address range of the security memory region, or is a fourth word if the access address does not belong to the address range of the security memory region. When the second control bit is the third word, it means that the memory page belongs to the security memory region; when the second control bit is the fourth word, it means that the memory page belongs to the non-security memory region.

The first word and the second word, and the third word and the fourth word may be any different words. For example, the first word and the second word are respectively 1 and 0, and the third word and the fourth words are respectively 1 and 0. This, the check result obtained in step S52 may be represented as (1, 1), (0, 1), (1, 0) and (0, 0).

The plurality of access permission lists are respectively four access permission lists corresponding to the four scenarios of the check result. Alternatively, two check results corresponding to the memory space in the first state share the same access permission list, i.e., the plurality of access permission lists are respectively three access permission lists respectively corresponding to the four scenarios of the check result. In one embodiment, the access permission lists may be set as: one or two access permission lists corresponding to the first state include only processor identifiers, an access permission list corresponding to the second state of the security memory region and an access permission list corresponding to the second state of the non-security memory region both include only hardware unit identifiers, a hardware unit identifier of an access permission list corresponding to the second state of the security memory region is set as a hardware unit identifier permitted to access the security memory region if it is in a security state, and a hardware unit identifier of an access permission list corresponding to the second state of the non-security memory region at least includes a hardware unit identifier set as permitted to access the non-security memory region if it is in a non-security state.

In step S54, an instruction is generated according to the search result. More specifically, step S54 includes following sub-steps.

In step S541, when the memory space belongs to the security memory region, if the accessor is in a security state, an instruction permitting the accessor to access the memory space is generated, otherwise an instruction not permitting the accessor to access the memory space is generated.

If it is determined that the memory space needed to be accessed is the security memory region and the accessor identifier belongs to the access permission set corresponding to the second state of the security memory region, the security memory protection mechanism becomes effective, and the memory controller permits the hardware unit in a security state to perform the access, and prohibits the hardware unit in a non-security state from the access and issues a system abnormality message, so as to prevent a hardware unit in a non-security state from erroneously accessing the security memory region due to a timing error or other reasons and thus from unlawfully acquiring or modifying the content of the security memory region.

In step S542, when the memory space belongs to the non-security memory region, regardless of whether the accessor is in a security state or a non-security state, an instruction permitting the accessor to access the memory space is generated. Alternatively, if the accessor is in a non-security state, an instruction permitting the accessor to access the memory space is generated, otherwise an instruction not permitting the accessor to access the memory space is generated.

If it is determined that the memory space needed to be accessed is the non-security memory region and the accessor identifier belongs to an access permission set corresponding to the second state of the non-security memory region, according to different application requirements, the memory controller permits hardware units in a security state and in a non-security state to perform the access. Alternatively, the memory controller permits only a hardware unit in a non-security state to perform the access, and prohibits a hardware unit in a security state from performing the access and issues a system abnormal message, so as to prevent a hardware unit in a security state from erroneously accessing the non-security memory region due to a timing error or other reasons and thus from causing contents needing protection from outputting to the non-security memory region.

In one embodiment in which the security memory region and the non-security memory region are distinguished, the plurality of access permission lists are similar to the above embodiment. However, an access permission list corresponding to the second state of the memory security region includes only hardware unit identifiers in a security state; an access permission list corresponding to the second state of the non-security memory region includes only hardware unit identifiers in a non-security state or hardware unit identifiers in a secure state and in a non-secure state. Correspondingly, generating an instruction according to the search result in step S54 includes: if it is determined in step S53 that the access permission set corresponding to the second state of the security memory region includes the identifier of the accessor, generating an instruction permitting the accessor to access the memory space, otherwise generating an instruction not permitting the accessor to access the memory space; if it is determined in step S53 that the identified access permission set corresponding to the second state of the non-security memory region includes the identifier of the accessor, generating an instruction permitting the accessor to access the memory space, otherwise generating an instruction not permitting the accessor to access the memory space.

Referring to FIG. 5, the memory access control method further includes: monitoring a current state of at least a part of the hardware unit; when the hardware unit is in a security state, classifying the hardware unit into the access permission list corresponding to the second state of the security memory region or returning the hardware unit to the access permission set corresponding to the second state of the non-security memory region; and when the hardware unit is in a non-security state, classifying the hardware unit into the access permission list corresponding to the second state of the non-security memory region. The at least a part of hardware unit at least include a hardware unit that is set to be permitted to access the predetermined memory region.

Concluded from above, the hardware unit identifier in the access permission list corresponding to the second state satisfies a configuration policy below: if the resource sharing is targeted at only the security memory region, the hardware unit identifier in the access permission list is a hardware unit identifier permitted to access if it is in a security state or is set to be in a security state. For the former, the memory controller may directly generate the instruction according to a final search result of step S54; for the latter, the memory controller needs to combine the final search result and the current state of the accessor to generate the instruction. If the resource sharing is further distinguished into the security memory region and the non-security memory region, the hardware unit identifier in the access permission list corresponding to the security memory region is a hardware unit identifier permitted to access if it is in a security state or is set to be in a security state; and hardware unit identifier in the access permission list corresponding to the non-security memory region at least includes a hardware unit identifier permitted to access if it is in a non-security state or is set to be in a non-security state.

In the foregoing embodiment where the predetermined memory region includes the security memory region and the non-security memory region, control logics according to which the memory controller controls the memory of the predetermined memory region are as Table-1 below. In Table-1, P is the first control bit, S is the second control bit, KProtect being effective indicates that the memory page is permitted to be accessed only by a processor but not a hardware unit, and the security memory protection mechanism is used to protect the security memory region in the second state and permits only access of a hardware unit in a security state.

TABLE 1
Control logics for accessing memory of predetermined memory region

| | | State of hardware | | Security memory protection |
|---|---|---|---|---|
| S | P | unit | KProtect | mechanism prohibiting access |
| 0 | 0 | Security state | Effective | No |
| 0 | 0 | Non-security state | Ineffective | No |
| 0 | 1 | Security state | Effective | No |
| 0 | 1 | Non-security state | Effective | No |
| 1 | 0 | Security state | Ineffective | No |
| 1 | 0 | Non-security state | Ineffective | Yes |
| 1 | 1 | Security state | Effective | No |
| 1 | 1 | Non-security state | Effective | No |

Analysis is performed on the security of the present invention by combining the above table.

Taking a terminal device operating in dual operation environments of TEE and Rich OS for instance, for each memory page in the predetermined memory region, there are three possible scenarios below.

1) If the control bit S is 1 and the control bit P is 0, it means that the memory of the memory page is allocated to TEE and is used as a security memory, and a hardware unit at this point is incapable of reading and writing the memory page, thus satisfying the requirement for a security memory in TEE.

2) If the control bit S is 1 and the control bit P is 1, it means that memory controller prohibits a hardware unit in a security state from writing to this memory page. Thus, a Rich OS end is prohibited from maliciously switching a memory page used by TEE to Rich OS, which may cause a hardware unit in a security state from continuing writing to this memory page without being aware of the above situation, further leading to data leakage to the Rich OS end.

3) If the control bit S is 1, the switching of the control bit P is performed by the memory controller to automatically clear the memory of the corresponding memory page, thus prohibiting a possible rollback attack or a Rich OS end from unlawfully acquiring output data of a hardware unit in a security state by frequently switching the control bit P.

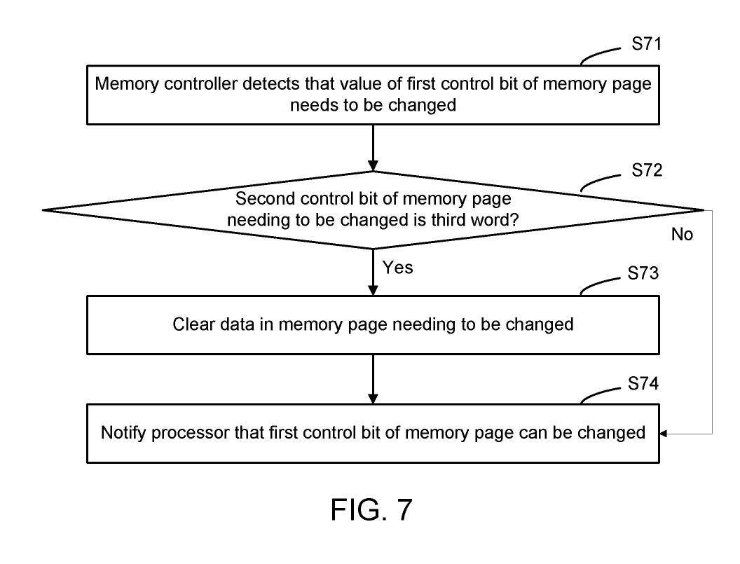

FIG. 7 shows a flowchart of a memory access control method according to another embodiment of the present invention. In addition to the above steps, this embodiment further includes following steps.

In step S71, the memory controller detects that the value of the first control bit in the memory page needs to be changed.

In step S72, it is determined whether the second control bit of the memory page needing to be changed is the third word. If so, it is determined that the memory page belongs to the security memory region and step S73 is performed, otherwise step S74 is performed.

In step S73, data in the memory page needing to be changed is cleared.

In step S74, the processor is notified that the first control bit of the memory page can be changed.

For example, as the embodiment in FIG. 3, before the processor performs step S32 or the predetermined memory region accessed by the operation is changed from the second state to the first state when it is determined that the operation of the hardware unit is completed, an instruction is issued to the memory controller to indicate that the value of the first control bit of the memory page associated with the predetermined memory region needs to be changed. At this point, to prevent rollback attack or theft of security data, the memory controller determines whether the memory page belongs to the security memory region. More specifically, the memory controller calculates the value of the second control bit of the memory page of which the first control bit needs to be changed, and determines whether the obtained value of the second control bit is the third word representing that the memory page belongs to the security memory region. If so, the data of the memory page is cleared to ensure that the operation data of the hardware unit in a security data is not unlawfully acquired by a subsequently accessing processor or hardware unit. After the clearing is completed or there is no need to perform the clearing, the memory controller notifies the processor by means of an interrupt that the first control bit of the memory page can be changed, i.e., the state of the memory page can be switched. After receiving the notification, the processor performs switching of the state of the memory page, otherwise the processor does not perform switching of the state of the memory page.

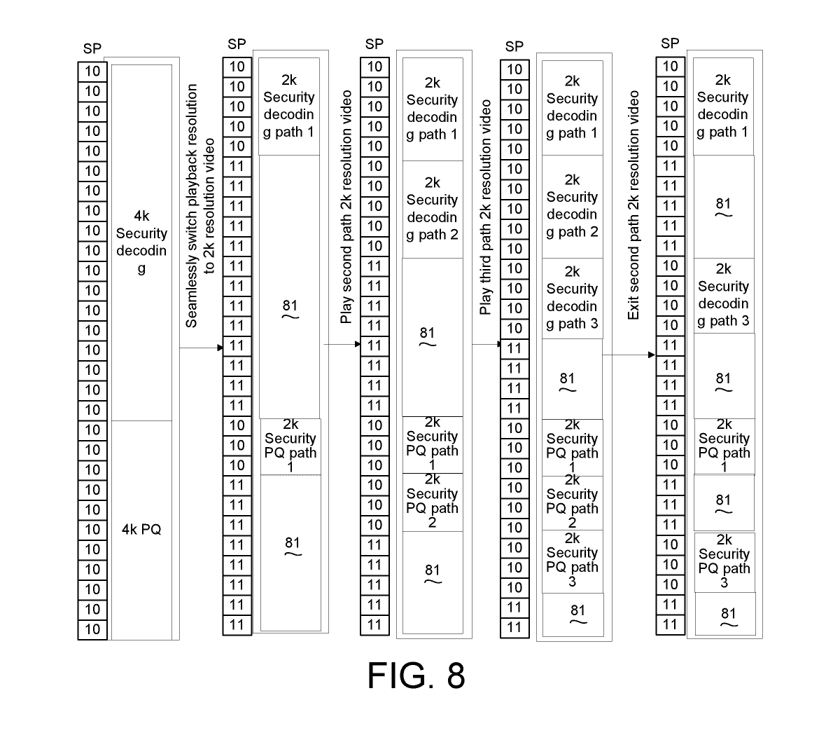

To better understand the present invention, an example is given with reference to FIG. 8 to illustrate how a playback end such as an playback end with an embedded platform is able to support multipath video decoding.

In a conventional solution where a security memory is independent from a system memory, in a situation when playback of multipath images is activated and terminated at any time point, fragmentation is caused in the allocation and use of the security memory. For example, assume that the size of the security memory is 300 MB, and there are images of two paths currently using a total of 90 MB of the security memory, leaving 210 MB of the security memory available. As such, a part of the security memory is constantly in use, in a way that a protection range in the security memory cannot be adjusted and the available memory region 81 cannot be shared to a system memory. Further, the number of available security memory region fragments 81 may be quite large. However, because the number of sections that can be protected by a conventional security memory is limited and a larger number of memory fragments cannot be supported, the security memory fragments 81 cannot be recycled.

With the present invention, the security memory region is provided in the system memory, and can be adjusted to be accessed by a hardware in a security state or by a processor through setting the state of the security memory region. As shown in FIG. 8, when the security memory region in the system memory is used for the above dual path image decoding, for the used memory page, the first control bit P is 0 and the second control bit S is 1, and for the memory page of the security memory fragments 81 that are not used, the first control bit P is 1 and the second control bit S is 1, thus enabling the recycling of the security memory fragments 81 for the use of a processor, e.g., Linux of an REE end. Thus, adjusting the use of a security memory region by setting the state of the security memory region achieves the recycling of security memory fragments, effectively utilizing the memory space as well as ensuring data safety as different range states ensure uses of different types of hardware.

A non-transient computer-readable storage medium is provided according to another embodiment of the present invention. The non-transient computer-readable storage medium is for managing a system memory accessed by a hardware unit, and stores a code readable and executable by a processor. The non-transient computer-readable storage medium is characterized in that, the code includes a first sub-code and a second sub-code.

The first sub-code determines, when an operation issued by the hardware unit is received, whether the operation requested by the hardware unit is accessing a security memory region in the system memory. For example, when the hardware unit is a 4K (UHD) decoder, the operation request includes information indicating that a security memory region in the system memory is accessed; when the hardware unit is an SD decoder, the operation request includes information indicating that the security memory region in the system memory is not accessed.

The second sub-code changes the security memory region needed to be accessed in the system memory from a first predetermined first state to a second state, and sets the hardware unit to a security state.

When the security memory region is in the first state, it means that the security memory region is permitted to be accessed only by a processor but not a hardware unit; when the security memory region is in the second state, it means that the security memory region is permitted to be accessed only by a hardware unit in a security state.

Selectively, the code further includes a third sub-code, which allocates, according to a memory allocation policy, one segment or a plurality of segments of continuous memory space in the system memory as the security memory region in the system memory.

Selectively, the security memory region includes a first quantity of memory pages, each of which is provided with a first control bit. The second sub-code determines that the size of the security memory region needed to be accessed to be a second quantity of memory pages, and changes the first control bits of the second quantity of memory pages in the security memory region from a first word to a second word. When the first control bit is the first word, it means that the memory page is in the first state; when the first control bit is the second word, it means that the memory page is in the second state. The first quantity is greater than the second quantity.

Selectively, the second sub-code further changes, when the operation requested by the hardware unit is not accessing the security memory region of the system memory, at least at part of the non-security memory region in the system memory from the first state to the second state, and sets the hardware unit to a non-security state. When the non-security memory region is in the first state, it means that the non-security memory region is permitted to be accessed only by a processor; when the non-security memory region is in the second state, it means that the non-security memory region is permitted to be accessed by a hardware unit in a security state or in a non-security state, or permitted to be accessed only by a hardware unit in a non-security state.

Selectively, the security memory region and the non-security memory region are both continuous memory regions allocated by the CMA in the system memory.

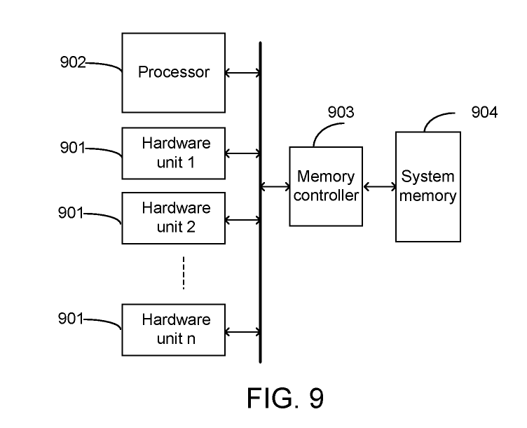

FIG. 9 shows a schematic diagram of a system structure using a memory access control method of the present invention. The system includes at least one hardware unit 901, a processor 902, and a system controller 903, all of which communicate with one another through a bus. A system memory 904 is accessed through the memory controller 903. The memory access control method in the foregoing embodiments may be applied to the system in FIG. 9, with the combination thereof further promoting further understanding of the present invention.

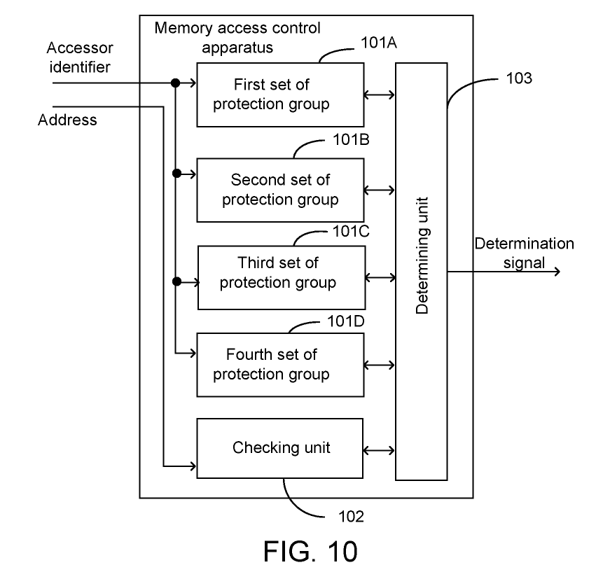

FIG. 10 shows a structural schematic diagram of a memory access control apparatus according to an embodiment of the present invention. In this embodiment, the memory access control apparatus includes multiple protection groups 101 (101A, 101B, 101C and 101D), a checking unit 102 and a determining unit 103.

The checking unit 102 receives an access address from a bus, checks whether a memory space pointed by the access address belongs to a security memory region of a predetermined memory region in a system memory, checks a current state of the memory space pointed by the access address to obtain a check result, and sends the check result to the determining unit 103.

The determining unit 103, connected to the plurality of protection groups 101A, 101B . . . and the checking unit 102, selects a search result according to the check result, and generates a determination signal according to the search result.

In one embodiment, if resource sharing is targeted at only the security memory region of the predetermined memory region, providing and setting the first control bit P is sufficient for implementing the memory access control of the present invention. The check result of the checking unit 102 is P=1 or P=1, and the protection function is achieved by involving merely two protection groups 101A and 101B. More specifically, the protection group 101A may set as determining whether the accessor identifier exists in a corresponding access permission list when the current state of the memory space pointed by the access address is the first state (i.e., P=1), and the search result is yes if the accessor identifier exists in the access permission list or the search result is no if the accessor identifier does not exist in the access permission list. The protection group 101B may set as determining whether the accessor identifier exists in a corresponding access permission list when the current state of the memory space pointed by the accessor identifier is the second state (i.e., P=0), and the search result is yes if the accessor identifier exists in the access permission list or the search result is no if the accessor identifier does not exist in the access permission list. For example, if the check result of the checking unit 102 is P=1, the determining unit 103 selects the search result provided by the protection group 101A; if the search result is yes, the determination signal is for permitting the accessor to access the memory space pointed by the access address, otherwise the accessor is not permitted.

In another embodiment, if whether the memory space pointed by the access address belongs to the security memory region of the predetermined memory region in the system memory needs to be distinguished, and the current state of the memory space pointed by the access address needed to be checked, memory access control of the present invention can be achieved by providing and setting two control bits S and P. The check result of the checking unit 102 is (S, P), which include (1, 1), (0, 10), (1, 0) and (0, 0), and four protection groups 101A, 101B, 101C and 101D are needed to achieve the protection function. More specifically, the protection group 101A may be set to determine whether the accessor identifier is in a corresponding access permission list when (S, P)=(1, 1), and the search result is yes if the accessor identifier is in the access permission list or the search result is no if the accessor identifier is not in the access permission list. The protection group 101B may be set may to determine whether the accessor identifier is in a corresponding access permission list when (S, P)=(0, 1), and the search result is yes if the accessor identifier is in the access permission list or the search result is no if the accessor identifier is not in the access permission list. The protection group 101C may be set may to determine whether the accessor identifier is in a corresponding access permission list when (S, P)=(1, 0), and the search result is yes if the accessor identifier is in the access permission list or the search result is no if the accessor identifier is not in the access permission list. The protection group 101D may be set may to determine whether the accessor identifier is in a corresponding access permission list when (S, P)=(0, 0), and the search result is yes if the accessor identifier is in the access permission list or the search result is no if the accessor identifier is not in the access permission list. For example, if the search result of the checking unit 102 is (S, P)=(1, 1), the determining unit 103 selects the search result of the protection group 101A; if the search result is yes, the determination signal permits the accessor to access the memory space range pointed by the access address, otherwise the accessor is not permitted.

In an actual application, when more control bits need to be provided and set, a larger number of protection groups may be used to achieve the protection function, and one person skilled in the art should know that such variation is within the scope of the present invention.

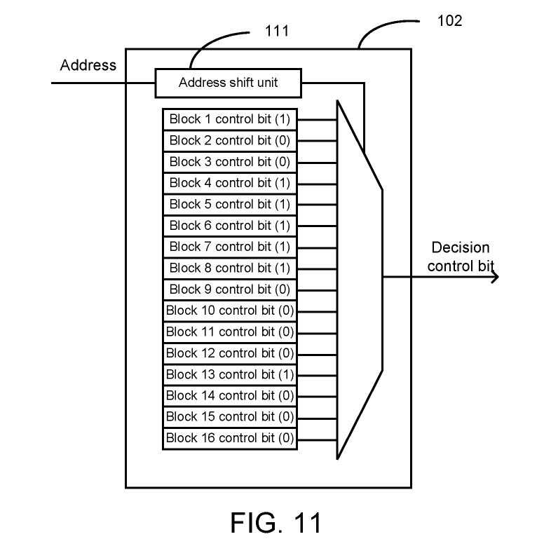

FIG. 11 shows a structural schematic diagram of a checking unit of the present invention. As shown in FIG. 11, the checking unit includes an address shift unit 111. When the access request enters the checking unit 102 of the memory access control apparatus, the address shift unit 111 acquires an access address from the address information of the bus, and the checking unit 102 determines the value of the control bit of the memory space corresponding to the access address according to the access address. In one embodiment, the checking unit 102 may be implemented by a multiplexer.

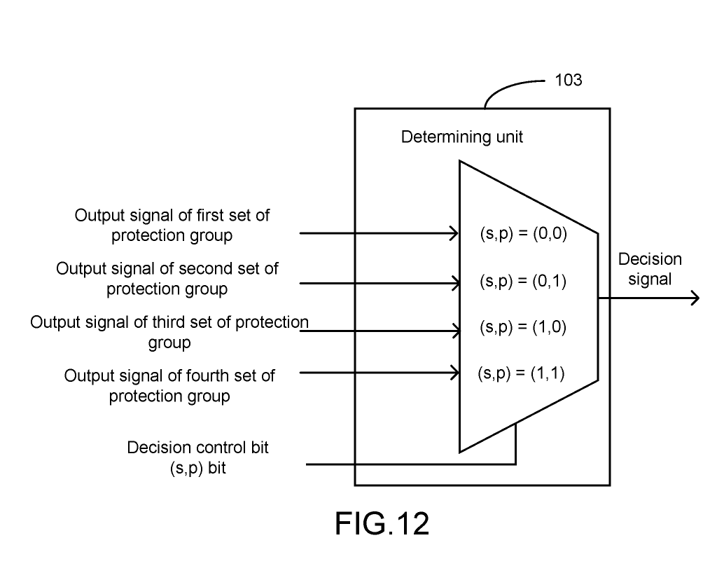

FIG. 12 shows a structural schematic diagram of a determining unit of the present invention. The determining unit 103 of the memory access control apparatus may be implemented by a multiplexer. The drawing depicts a scenario with two control bits S and P, and other scenarios with other multiple control bits may be provided in other embodiments. Such details are omitted herein.

A security issue may be caused after sharing memory resources, and hence a memory region protection mechanism is adopted. The memory region protection mechanism is applied to protect a memory access range of a kernel of an operating system, allowing a central processing unit (CPU) or a hardware unit of specific type to access this region and preventing damage of the data of the kernel of an operating system. In a conventional protection mechanism, only a section of continuous memory region can be used as a unit, and one set of protection group can satisfy required conditions. When the memory is shared and re-allocated, the original continuous protection region may be divided into several sections that are respectively accessed by a CPU or other hardware units. Thus, a plurality sets of protection groups need to be provided individually, and each of the protection groups provides a function of protecting the section corresponding to that set to be accessed only by predetermined CPU or hardware units of specific types. In the present invention, only two sets or four sets of protection groups are needed to protect the corresponding memory space without affecting memory spaces already allocated to other hardware units. Thus, the operating system does not occupy multiple protection groups, thus significantly reducing costs of protection groups for the memory space. Particularly, when the original continuous memory region is split into more than two or four areas, the costs reduced by the protection mechanism of the protection are further emphasized.

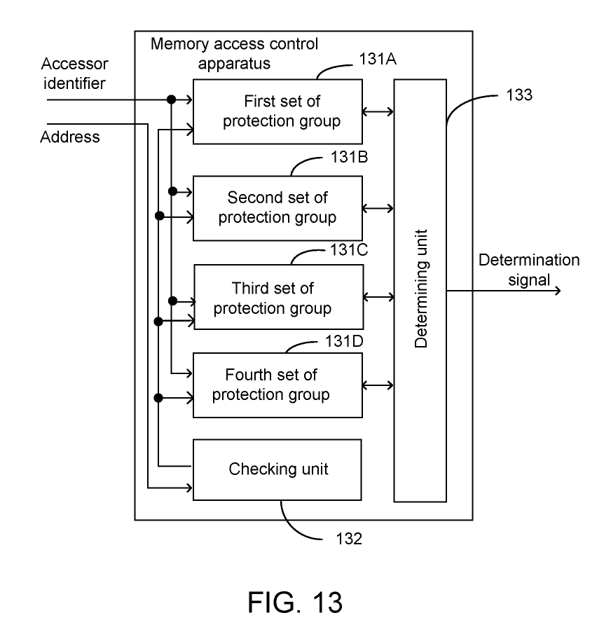

FIG. 13 shows a structural schematic diagram of a memory access control apparatus according to another embodiment of the present invention. In this embodiment, the memory access control apparatus is fundamentally similar to the protection groups and units of the apparatus in FIG. 10, and differs in that, a plurality of protection groups 131 (131A, 131B, 131C and 131D) are connected to a checking unit 132, and a determining unit 133 is connected to the plurality of protection groups 131. The plurality of protection groups 131 selects a protection group according to the check result of the checking unit 132 to look up an access permission list corresponding to an accessor identifier to obtain a search result. The determining unit 133 directly receives the search result of the protection group corresponding to the check result, and generates a determination signal according to the search result.

The corresponding unit structures of the memory access control apparatus further perform corresponding steps in the above memory access control method of the foregoing embodiments. Details may be referred from the description associated with the foregoing embodiments.

The above processor may be referred to as a CPU, and the above memory controller may be a system-on-chip (SoC). In an actual application, the components of the terminal device may be coupled to one another through a bus (not shown). The bus may include, in addition to a data bus, a power bus, a control bus and a state signal bus.

The method disclosed by the embodiments of the present invention is applicable in a processor or in a memory controller, or is implemented by a processor or a memory controller. The processor or memory controller may be an integrated circuit chip with signal processing capabilities. In implementation, the steps of the above method may be completed by integrated logic circuits in the hardware or instructions in form of software in the processor or the memory controller. The above processor or memory controller may be a universal processor, a digital signal processor (DSP), an application-specific integrated circuit (ASIC), a programmable field gate array (FPGA) or other programmable design logic components, independent logic gates, transistor logic components or independent hardware components. The universal processor may be a microprocessor or the processor may be any standard processor. The steps combining with the method disclosed by the present invention may be directly performed and completed by hardware circuits, or performed in combination by hardware in hardware circuits and software modules. Software modules may be located in a matured storage medium in the technical field including random access memory (RAM) read-only memory (ROM), programmable read-only memory, electrically erasable programmable memory and registers. The storage medium is located in the memory, the processor or the memory controller to read information in the memory so as to combine with hardware thereof to achieve the above steps.

The above solutions provides following effects.

1) The system memory and the security memory range share a physical memory in a time-division manner, reducing a total memory requirement of the system.

2) Sufficient robustness is provided, and data conflict between a hardware unit and a processor is not caused even in the presence of code error of third-party manufacturers or other timing issues.

3) Sufficient security is provided, which prevents rollback attacks such as a processor or a hardware unit in a non-security state or operating in Rich OS feeding data to a hardware unit in a TEE, and prevents a processor or a hardware unit in a non-security state from unlawfully acquiring data of a security memory region.

4) From the perspective of hardware cost analysis, no additional security memory needs to be provided in the solution of the present invention, reducing system costs and further reducing system costs by reducing the number of protection groups.

Further, larger pages, such as 1 MB and 512 KB large micro memory pages, are used in the solution. Meanwhile, instead of numerous control bits needed by each memory page in a conventional MMU, each page of the solution of the present invention requires only one one-bit control bit to set a state thereof, thus significantly lowering the internal storage bit requirement of hardware, further reducing system storage costs.

In the several embodiments provided by the present invention, it should be appreciated that, the method and apparatus disclosed may be implemented through other means. For example, the implementation of the apparatus described above is only illustrative, e.g., the division of the module or unit is a logic function division, and there may be other division means in actual applications. For example, multiple units or components may be combined or may be integrated to another system. Alternatively, certain features may be omitted or left unexecuted.

The units described as separate components may or may not be physically separate, and components displayed as units may or may not be physical units, that is, these units may be located at one place or may be distributed on multiple network units. A part of or all of the units described may be selected according to actual needs to achieve the objects of the solution of the present invention.

Further, the function units of the embodiments of the present invention may be integrated into one processing unit, may be physically exist as independent units, or may be integrated in pairs or more into one unit. The integrated unit may be implemented in form of hardware, or may be implemented in form of software function units.

When the integrated units in other embodiments are implemented in form of software function units and serve as independent products for sale or for use, these integrated units may be stored in a computer-readable storage medium. Based on such understanding, the technical solution of the present invention, a part contributing towards prior art, or all of or a part of the technical solution may be presented in form of software products. The computer software product is stored in a storage medium, and includes multiple instructions to cause a computer device (e.g., a personal computer, a server or a network apparatus) or a processor to execute all of or a part of the steps of the method of the embodiments. The foregoing storage medium includes a medium capable of storing various codes, such as USB flash drive, portable disk, ROM, RAM, magnetic disk or optic disk.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A memory space management method, for managing a system memory accessed by a hardware unit or a processor, comprising:
upon receiving an operation request issued from the hardware unit, determining, according to a type of the operation request, whether an operation requested by the hardware unit is accessing a security memory region in the system memory; and
if so, changing the security memory region needed to be accessed in the system memory from a predetermined first state to a second state, and setting the hardware unit to a security state;
wherein, when the security memory region is in the first state, it means that the security memory region is permitted to be accessed only by the processor but not the hardware unit; when the security memory region is in the second state, it means that the security memory region is permitted to be accessed only by the hardware unit in the security state.

2. The method according to claim 1, further comprising:
when a system is booted, allocating one segment or a plurality of segments of memory in the system memory according to a memory allocation policy as the security memory region in the system memory.

3. The method according to claim 1, wherein the security memory region comprises a first quantity of memory pages, each of the memory pages is provided with a first control bit, and the step of changing the security memory region needed to be accessed in the system memory from the predetermined first state to the second state comprises:
determining a size of the security memory region needed to be accessed to be a second quantity of memory pages;
changing the first control bit of each of the second quantity of memory pages in the security memory region from a first word to a second word;
wherein, when the first control bit is the first word, it means that the memory page is in the first state; when the first control bit is the second word, it means that the memory page is in the second state; the first quantity is greater than the second quantity.

4. The method according to claim 1, further comprising:
if the operation requested by the hardware unit is not accessing the security memory region in the system memory, changing at least a part of the non-security memory region in the system memory from the first state to the second state, and setting the hardware unit to a non-security state;
wherein, when the non-security memory region is in the first state, it means that the non-security memory region is permitted to be accessed only by the processor; when the non-security memory region is in the second state, it means that the non-security memory region is permitted to be accessed by the hardware unit in the security state or in the non-security state, or permitted to be accessed only by the hardware unit in the non-security state.

5. The method according to claim 4, wherein the security memory region and the non-security memory region are both continuous memory regions in the system memory and allocated by a continguous memory allocator (CMA).

6. A memory access control method, for controlling a system memory accessed by a processor or a hardware unit, comprising:
upon receiving an access request, acquiring an access address and an identifier of an accessor in the access request;
checking a current state of a memory space pointed by the access address to obtain a check result, wherein the state of the memory space comprises a first state and a second state;
looking up whether the identifier of the accessor belongs to an access permission set among a plurality of access permission lists that corresponds to the check result to generate a search result, wherein the plurality of access permission sets comprises a first access permission list corresponding to the first state and a second access permission list corresponding to the second state; and
generating an instruction according to the search result, wherein the instruction indicates whether or not the accessor is permitted to access the memory space.

7. The method according to claim 6, wherein the step of checking the current state of the memory space pointed by the access address to acquire the check result comprises:
checking the current state of the memory space pointed by the access address, and checking, according to the access address, whether the memory space pointed by the access address belongs to a security memory region of a predetermined memory region in the system memory to obtain the check result.

8. The method according to claim 7 wherein the step of generating the instruction according to the search result comprises:
when the memory space belongs to the security memory region, if the accessor is in the security state, generating the instruction permitting the accessor to access the memory space, otherwise generating the instruction not permitting the accessor to access the memory space;
when the memory space belongs to the non-security memory space, regardless of whether the accessor is in the security state or the non-security state, generating the instruction permitting the accessor to access the memory space; alternatively, when the accessor is in the non-security state, generating the instruction permitting the accessor to access the memory space, otherwise generating the instruction not permitting the accessor to access the memory space.

9. The method according to claim 7, wherein the predetermined memory region comprises a plurality of memory pages, each of the memory pages is provided with a second control bit, and the step of checking, according to the access address, whether the memory space pointed by the access address belongs to the security memory region of the predetermined memory region in the system memory comprises:
calculating a value of the second control bit of the memory page pointed by the access address according to a relationship between the access address and an address of the security memory region of the predetermined memory region;
wherein, when the second control bit is a third word, it means that the memory page belongs to the security memory region; when the second control bit is a fourth word, it means that the memory page belongs to the non-security memory region.

10. The method according to claim 6, wherein the predetermined memory region comprises a plurality of memory pages, each of the memory pages is provided with a first control bit, and the step of checking the current state of the memory space pointed by the access address comprises:
reading a value of the first control bit of the memory page pointed by the access address to determine the current state of the memory page pointed by the access address;
wherein, when the first control bit is a first word, it means that the memory page is in the first state; when the first control bit is a second word, it means that the memory page is in the second state.

11. The method according to claim 10, further comprising:
upon detecting that the value of the first control bit of the memory page needs to be changed, determining whether the memory page needing to be changed belongs to the security memory region; and
if so, clearing data in the memory page needing to be changed.

12. A computer-readable storage medium, for managing a system memory accessed by a processor or a hardware unit, storing a code readable and executable by the processor, wherein the code comprises:
a first sub-code, upon receiving an operation request issued from the hardware request, determining, according to a type of the operation request, whether an operation requested by the hardware unit is accessing a security memory region in the system memory; and
a second sub-code, changing the security memory region needed to be accessed in the system memory from a predetermined first state to a second state, and setting the hardware unit to a security state;
wherein, when the security memory region is in the first state, it means that the security memory region is permitted to be accessed only by the processor but not the hardware unit; when the security memory region is in the second state, it means that the security memory region is permitted to be accessed only by the hardware unit in the security state.

13. A memory access control apparatus, connected to a system memory, for controlling a processor or a hardware unit to access the system memory, the memory access control apparatus comprising:
a plurality of protection groups, each of which looking up an access permission list according to an accessor identifier to obtain a search result;
a checking unit, checking whether a current state of a memory space pointed by the access address is a first state or a second state to obtain a check result; and
a determining unit, connected to the plurality of protection groups and the checking unit, receiving the plurality search results and the check result, selecting one of the plurality of search results according to the check result, and generating a determination signal according to the selected search result.

14. The memory access control apparatus according to claim 13, wherein when the memory space pointed by the access address is in the first state, it means that the memory space is permitted to be accessed only by the processor but not the hardware unit; when the memory space pointed by the access address is in the second state, it means that the memory space is permitted to be accessed only by the hardware unit in the security state.

15. The memory access control apparatus according to claim 13, wherein the checking unit determines, according to a value of a first control bit of the memory space, whether the current state of the memory space pointed by the access address is the first state or the second state, and the plurality of protection groups are two protection groups.

16. The memory access control apparatus according to claim 15, being characterized in that, when the first control bit is a first word, it means that the memory space is in the first state; when the first control bit is a second word, it means that the memory space is in the second state; if the check result indicates that the first control bit is the first word, the determining unit generates the determination signal according to the search result of a first protection group among the plurality of protection groups; and if the check result indicates that the first control bit is a second word, the determining unit generates the determination signal according to the search result of a second protection group among the plurality of protection groups.

17. The memory access control apparatus according to claim 13, wherein the checking unit further determines whether the memory space pointed by the access address belongs to a security memory region of a predetermined memory region in the system memory, and determines whether the memory address pointed by the access address belongs the security memory region of the predetermined memory region in the system memory and the current state of the memory space according to values of the first control bit and the second control bit, and the plurality of protection groups are four protection groups.

18. The memory access control apparatus according to claim 17, wherein when the first control bit is a first word, it means that the memory space is in the first state; when the first control bit is a second word, it means that the memory space is in the second state; when the second control bit is a third word, it means that the memory space pointed by the access address belongs to the security memory region of the predetermined memory region in the system memory; when the second control bit is a fourth word, it means that the memory space pointed by the access address does not belong to the security memory region of the predetermined memory region in the system memory; the four protection groups are respectively a third protection group, a fourth protection group, a fifth protection group and a sixth protection group; if the check result indicates that the first control bit is the first word and the second control bit is the third word, the determining unit selects the third protection group; if the check result indicates that the first control bit is the second word and the second control bit is the third word, the determining unit selects the fourth protection group; if the check result indicates that the first control bit is the first word and the second control bit is the fourth word, the determining unit selects the fifth protection group; if the check result indicates that the first control bit is the second word and the second control bit is the fourth word, the determining unit selects the sixth protection group; if the search result of the third protection group, the fourth protection group, the fifth protection group or the sixth protection group is yes, the determination signal permits accessing to the memory space pointed by the access address.

19. The memory access control apparatus according to claim 13, wherein the checking unit comprises an address shift unit for acquiring the access address from address information in a bus.

20. A memory access control apparatus, connected to a system memory, for controlling a processor or a hardware unit to access the system memory, the memory access control apparatus comprising:
a checking unit, checking, according to an access address, whether a current state of a memory space pointed by the access address is a first state or a second state to obtain a check result;
a plurality of protection groups, connected to the checking unit, wherein the protection group corresponding to the check result looks up an access permission list according to an accessor identifier to obtain a search result; and
a determining unit, connected to the plurality of protection groups, receiving the search result corresponding to the check result, and generating a determination signal according to the search result.
